(19) United States
(12) Patent Application Publication
(10) Pub. No.: US 2008/0207990 A1
(43) Pub. Date: Aug. 28, 2008

(54) Vibration massager with visual control communication

(75) Inventor: Simon Siu Man Nan, Ontario (CA)

Correspondence Address: GREENSFELDER HEMKER & GALE PC, SUITE 2000, 10 SOUTH BROADWAY, ST LOUIS, MO, 63102, US

(73) Assignee: Nanma Manufacturing Co. Ltd., Chai Wan (HK)

(21) Appl. No.: 11/710,796

(22) Filed: Feb. 26, 2007

(51) Int. Cl. A61H 19/00

(52) U.S. Cl. 600/38

(57) ABSTRACT

An electrically powered massage device has a hand-held unit containing a power source and operation control units extended from. It includes a squirming massage actuator as well as a vibration massage actuator connected to the squirming massage actuator. The hand-held unit contains a battery chamber carrying a plurality of batteries for providing electric power to the device The hand-held unit comprises also an electronic control unit for controlling device operation, and includes a control panel with operation pushbuttons on its outer surface. On said outer surface there is a chamber with transparent cover loosely encasing a plurality of artificial diamonds for visual attractiveness.

### BACKGROUND AND SUMMARY

The present invention relates generally to massage devices, especially as they relate to electrically powered vibrating massage devices having control panels, and more particularly, to such a vibration massager of the type used for therapeutic sexual massage or sexual aid, wherein a control panel of the massager has visual communication means.

In the art of the vibrating massager, especially those of sexual aid devices, there is a large emphasis on physical contact stimulation provided by the product. Improvements on exiting massagers is focused on product shape, dimension, surface finish, vibrating and stimulation modes, etc., all aiming at increasing the physical contact stimulation applied to the body areas concerned. However, certain additional functions of the massager which can help to enhance the sexual aid application, for example visual attractiveness, are omitted by the existing designs because of product complexity and high cost. A low cost solution of the visual attractiveness from the product has been missing for so long in the conventional designs. Other secondary functions which can provide enhancements to the massaging function but are absent in conventional designs include enabling visual communications through the control panel of the massager (but without additionally consuming energy), providing controlled temperature of the device, and indicating the vibration strength, for example. The aforementioned shortcomings of the conventional designs are such that existing massagers have not all the advantages, benefits, features, goals and objectives herein noted. Thus, a need exists to provide a device having some or all of these advantages, benefits, features, goals and objectives.

Among a few of the advantages, benefits, features, goals and objectives obtained by one or more embodiments of the presently described technology are as follows.

One or more embodiments of the presently described technology provide a massage device that includes a vibration actuator or actuators and a control panel having a transparent cover, such that the space beneath the cover caries movable objects which can provide, but not limit, a visual communication function in addition to a massaging function.

One or more embodiments of the presently described technology provide a massage device which provides aesthetic attractiveness of the product in addition to the massaging function.

One or more embodiments of the presently described technology provide an electrically powered massage device, specially used as a sexual aid or therapeutic device, with a control panel having an additional front cover arrangement in which various systems can be integrated for providing visual communication functions without consuming energy.

One or more embodiments of the presently described technology provide an electrically powered massage device with a control panel having an additional front cover arrangement in which various systems can be integrated for providing visual communication functions under various application environments.

One or more embodiments of the presently described technology provide an electrically powered massage device with advantageous visual communication capacity without increasing manufacturing complexity.

Briefly, an electrically powered massage device of an embodiment of the invention comprises a hand-held unit containing a power source, a massage actuator, and operation control devices. A disclosed embodiment includes a squirming massage actuator as well as a vibration massage actuator connected to the squirming massage actuator. The hand-held unit presently disclosed contains a battery chamber accommodating a battery cartridge or casing providing a chamber for carrying a plurality of batteries for providing electric power to the device, there being an end-cover for covering the battery chamber. The hand-held unit comprises also an electronic control unit for controlling device operation, and further comprises a control panel with operation pushbuttons on its outer surface. On the outer surface there is a chamber with transparent cover loosely encasing a plurality of artificial diamonds for visual attractiveness.

### DRAWINGS

FIG. 1 illustrates a perspective-type view of completely assembled device in accordance with an embodiment of the present invention.

FIG. 2 illustrates a perspective-type view of the device of FIG. 1 with the end cover and battery cartridge detached from the device in accordance with an embodiment of the present invention.

FIG. 3 illustrates an exploded view of the components/units making up the device of FIG. 1 in accordance with an embodiment of the present invention.

Corresponding reference characters indicate corresponding parts in multiple figures of the drawings.

### DESCRIPTION

A preferred embodiment of the present invention is presented, by way of example only, with reference to the accompanying drawings.

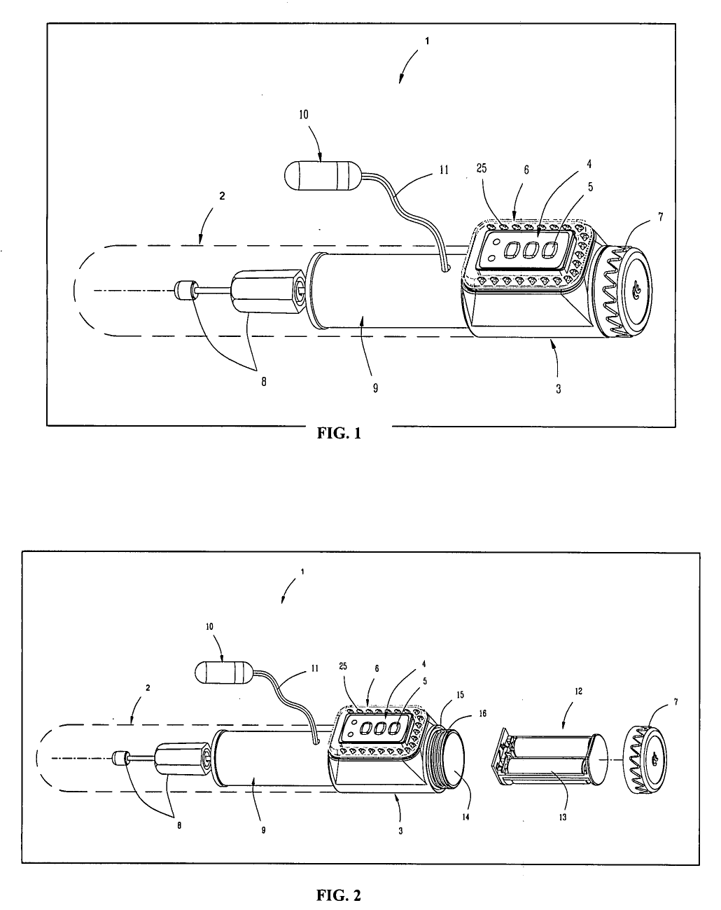

Referring to FIG. 1, in one preferred embodiment of the present invention, electrically powered massage device 1 comprises a squirming actuator with a prosthetic phallic-simulative member 2 made of suitable resilient material. The resilient material can be of appropriate thickness as heretofore employed in patented or published disclosures of the present inventor's previous devices for comparable therapeutic or sexual aid use.

The massage device includes a hand-held portion 3 having a control panel 4 and pushbuttons 5, a transparent cover 6 closing a chamber which encases a plurality of aesthetic objects 25 arranged in an array which at least partly surrounds control panel 4, an end-cover 7, a squirming producing unit 8 and its driving unit 9, a vibration massage actuator 10 and a power cable 11 connecting to the power source inside the device. In an embodiment of the presently described device 1, aesthetic objects 25 include one or more types of reflective or refractive objects that reflect or refract light in such a way as to attract one's attention to the control panel 4. For example, aesthetic objects 25 can be embodied in one or more of artificial diamonds, nonprecious or semiprecious stones, or other objects useful to produce a desired visual effect. The objects 25 may be so-called white (uncolored) objects or may be of colored types of objects. While objects 25 are referred to as “diamonds” herein, the scope of embodiments of the presently described device 1 are not limited to using diamonds or artificial diamonds as objects 25.

Referring to FIG. 2, the hand-held portion 3 defines a battery chamber with an opening 14 for accepting battery cartridge 12 carrying batteries 13. At the opening of the battery chamber and on the outside circumference of the chamber terminal there is provided an external screw thread 16. A corresponding internal screw thread (not shown but inferred by the external screw thread 16) disposed in the internal circumference and at the opening of the end-cover 7 is provided to engage with and fasten onto the external screw thread 16.

A sealing element 15 made of resilient material can be disposed between the hand-held portion 3 and the end-cover 7. When the end-cover 7 is fastened onto the hand-held portion 3 a sealing between the two parts can be established. In certain embodiments, a water-tight seal can be established.

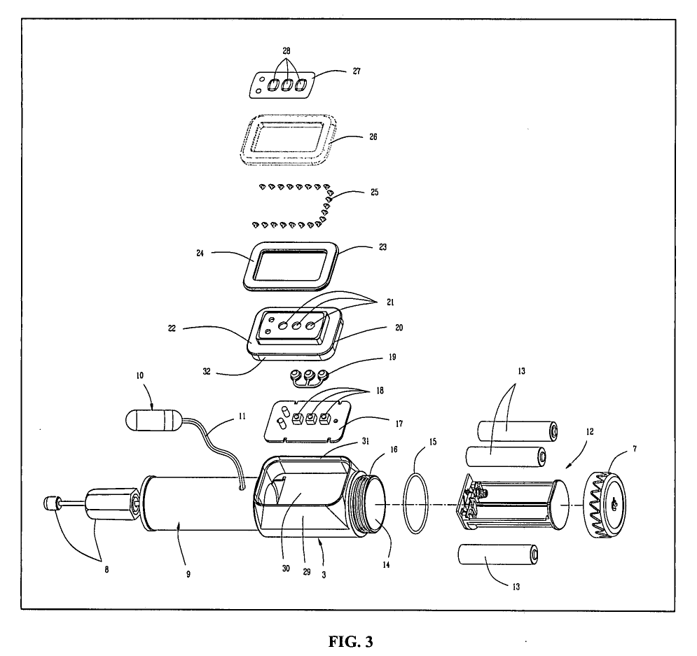

Now referring to FIG. 3, the hand-held portion 3 is provided with an elongated radial extension, a so-called boss, 29 having edge-rounded character at its ends relative to the axis of elongation. Boss 29 defines a chamber 30 having an opening 31 for accommodating the control unit of the massage device.

The control unit comprises a printed circuit board (PCB) 17 containing a suitable control circuit carrying a set of pushbutton switches 18 for operating various functions, a set of button caps 19 for correspondingly putting on the pushbutton switches 18, a front cover 20 having a skirt portion 32 at its lower side and a set of through holes 21 on the top surface for correspondingly accepting the button caps 19 and a step surface 22 for fitting a base plate 23 which has a hardening surface 24, a plurality of artificial diamonds 25, a transparent or translucent cover 26 made in a reversed channel form for accommodating the artificial diamonds 25, and a membrane 27 having a set of pushing portions 28 corresponding to the pushbutton switches 18.

By placement of cover 26 with respect to base plate 23 and hardening surface 24, a channel is formed in which one or more of artificial diamonds 25 can be inserted. The channel can be rectangular, square, circular in shape or in the shape of any other two-dimensional geometric object. In an embodiment of the presently described device, the channel can surround a face or surface of the control panel 4 so as to be located just inside a circumference of the face.

Artificial diamonds 25 can be arranged in an array or continuous sequence provided by successive placement so that the array of the diamonds at least partly surrounds control panel 4 by means of said cover 26 channel form, and in the embodiment shown, to provide a lateral end section of diamonds and two parallel longitudinal extensions of the diamond array extending around a corresponding three portions of boss 29. The artificial diamonds 25 may most preferably be loosely fitted for permitting movement on reorientation of the massage device, as will most readily attract attention, or may instead be closely or tightly fitted in adjacent relationship for fixed location, according to the visual effect desired. That is, diamonds 25 can be loosely positioned inside the channel formed by cover 26 so as to vibrate and thus move as device 1 vibrates, for example. Diamonds 25 can be loosely positioned inside the channel in a number of ways. For example, diamonds 25 can be placed inside channel in a sufficiently low density so as to allow movement of diamonds 25 with respect to the cover 26. In another example, a circumference of diamonds 25 can be sufficiently small so as to permit movement of diamonds 25 with respect to the cover 26. As cover 26 is preferably transparent or translucent, diamonds 25 are visible to users of device 1 during operation of device 1.

As an alternative to the orientation of three diamond segments, four segments or extensions of artificial diamonds may be provided so as to fully surround control panel 4, it being understood that if loosely fitted, the artificial diamonds can be free, if desired, to be able to move around four segments.

Other groupings of the diamonds are also possible, such as parallel grouping of two segments, with the artificial diamonds either loosely or tightly fitted.

In the foregoing orientations and every possible orientation of comparable effect the array of artificial diamonds provides novel and useful visual effect. The diamonds highlight the control panel and by their light-gathering effect provide for immediate visual location of the control panel, even in a semi-darkened room, and in every possible variation providing visual orientation and location as well as enabling visual communications through the control panel of the massager but without additionally consuming energy from the batteries.

Instead of artificial diamonds other nonprecious or semiprecious stones may be used according to desired visual effect. The artificial diamonds may be so-called white (uncolored) or may be of colored types.

In the assembly of the vibratory massager, the front cover 20 with its skirt portion 32 engaged with terminal edge of opening 31 of boss 29 encases the PCB17 carrying the button caps 19; the membrane 27 will then be affixed on the front cover 20 forming the control panel. Elements 23, 25 and 26 are integrated into a subassembly unit which is then affixed on the top of the front cover 20.

As materials of construction suitable well-known polymers and resins of waterproof character may be employed for the structural components for hand-held portion 3 and its control panel 4 and pushbuttons 5, and transparent cover 6.

As various modifications could be made in the constructions and methods herein described and illustrated without departing from the scope of the invention, it is intended that all matter contained in the foregoing description or shown in the accompanying drawings shall be interpreted as illustrative rather than limiting.

What is claimed is:

1. A massage device including:
a cover forming a channel on a hand-held portion of said device; and
a plurality of objects located in said channel and visible to a user of said device.

2. The device of claim 1, wherein said cover is at least one of transparent and translucent.

3. The device of claim 1, wherein at least one of said objects is capable of moving with respect to said cover when said device is operated by a user.

4. The device of claim 1, wherein each of said objects includes at least one of a reflective and refractive object.

5. The device of claim 1, wherein at least one of said objects includes at least one of an artificial diamond and a stone.

6. The device of claim 1, wherein said channel is configured to cause said channel to surround one or more pushbutton switches capable of being operated to cause said device to vibrate.

7. The device of claim 6, wherein said cover is configured to cause said channel to be rectangular in shape.

8. The device of claim 7, wherein said plurality of objects in said channel surround said pushbutton switches.

9. A control panel device for a massage device, said control panel including:
a plurality of objects capable of reflecting light enclosed in a channel on said control panel.

10. The control panel device of claim 9, wherein said plurality of objects include one or more of an artificial diamond and a stone.

11. The control panel device of claim 9, further including a cover placed relative to said control panel device so as to define a channel.

12. The control panel device of claim 11, wherein said channel surrounds a surface of said control panel device.

13. The control panel device of claim 11, wherein said plurality of objects are located within said channel.

14. The control panel device of claim 13, wherein at least one of said plurality of objects is capable of moving relative to said cover.

15. A massage device including a plurality of visible objects capable of moving in a channel during operation of said device.

16. The device of claim 15, wherein each of said objects is one or more of an artificial diamond and a stone.

17. The device of claim 15, wherein said channel is defined by a cover placed relative to said device so as to encase said objects in said channel.

18. The device of claim 15, wherein said cover is translucent.

19. The device of claim 15, wherein said cover is transparent.

20. The device of claim 15, wherein said channel surrounds one or more pushbuttons.
